(19) United States
(12) Patent Application Publication
(10) Pub. No.: US 2020/0269216 A1
(43) Pub. Date: Aug. 27, 2020

(54) NANO-CATALYST COMPOSITE FOR DECOMPOSING FORMALDEHYDE AT ROOM TEMPERATURE AND PREPARATION METHOD THEREOF

(71) Applicant: CHINA JILIANG UNIVERSITY, Hangzhou (CN)

(72) Inventors: LILI FAN, HANGZHOU (CN); YUEXIANG HUANG, HANGZHOU (CN)

(21) Appl. No.: 16/545,800

(22) Filed: Aug. 20, 2019

(30) Foreign Application Priority Data
Feb. 25, 2019 (CN) 201910136997.6

(51) Int. Cl. B01J 23/34; B01J 35/00; B01J 35/02; B01J 37/34; B01D 53/86

(52) U.S. Cl. CPC B01J 23/34; B01J 35/006; B82Y 40/00; B01J 37/342; B01D 53/8668; B01J 35/023

(57) ABSTRACT

Some embodiments of the disclosure provide a nano-catalyst composite for decomposing formaldehyde at room temperature and a preparation method. According to an embodiment, a nano-catalyst composite includes an alumina carrier of a nano dual-via structure. An inner part and a surface of the nano-alumina dual-via structure are loaded with a non-stoichiometric nano-metal manganese dioxide (MnO₂₋ₓ) catalyst. According to another embodiment, a preparation method of a nano-catalyst composite for decomposing formaldehyde at room temperature includes the following steps. (1) Loading manganese dioxide onto the nano-alumina carrier by an electron beam thermal evaporation technology. (2) Conducting hydrogenation treatment on the manganese dioxide catalyst on the nano-alumina carrier under a condition of specific hydrogen pressure, specific temperature, and a specific hydrogenation time, to obtain the non-stoichiometric nano manganese dioxide (MnO₂₋ₓ) catalyst.

### CROSS REFERENCE TO RELATED APPLICATIONS

This application claims priority to Chinese application number 20191013699-7.6, filed on Feb. 25, 2019, the disclosure of which is incorporated by reference herein in its entirety.

### FIELD OF THE DISCLOSURE

The disclosure relates generally to the field of air purification catalytic application materials. More specifically, the disclosure relates to a nano-catalyst composite for decomposing formaldehyde at room temperature and a preparation method thereof.

### BACKGROUND

Formaldehyde (HCHO) is a common indoor air pollutant, and can interact with an amino acid in a human protein and affect a normal function of the protein. The formaldehyde may cause damage to an olfactory sense or other sense systems, a respiratory system, an immune system, and a central nervous system of a human body, and may also have an adverse effect on human inheritance. A relatively low concentration of formaldehyde may irritate an eye and an upper respiratory tract, causing an acute anaphylactic reaction. A medium concentration of formaldehyde may cause symptoms such as severe burns in a respiratory tract, runny nose, difficult breathing, headache, and the like; and an excessively high concentration of formaldehyde may cause pulmonary edema and pneumonia, induce genetic mutations, and even cause death. Main sources of indoor formaldehyde or formaldehyde in a car are adhesives in a decoration material and a furniture material. Especially in a newly decorated room, a large quantity of decoration materials indoors emit a large amount of formaldehyde, and consequently the formaldehyde content in indoor air seriously exceeds the national standard.

There is a plurality of methods currently used for removing formaldehyde, which can be roughly classified into a window-opening ventilation method, an adsorption method, a photo-catalytic oxidation method, an ozone oxidation method, and a metal oxide catalytic degradation method. The window-opening ventilation method is simple to operate, but a long-term effect is not obvious due to a long release period of formaldehyde. When the adsorption method is used to remove formaldehyde, formaldehyde is only enriched on an adsorbent and cannot be decomposed, and secondary pollution is caused during desorption. In the photo-catalytic oxidation method, currently, a photocatalyst commonly used currently is titanium dioxide, which can be used for catalytic degradation of formaldehyde, organic matters, and the like. However, because the titanium dioxide photocatalyst only responds to ultraviolet light, catalytic degradation efficiency cannot satisfy an actual requirement, a system design requirement is relatively high, and it is difficult to conduct large-scale promotion. In the ozone oxidation method, a strong oxidizing property of ozone is used to catalyze formaldehyde decomposition. However, ozone is toxic. In ozone of a concentration of 0.1 ppm to 1 ppm, people have headaches and eye burning and suffer respiratory tract irritation. In this case, it is difficult to actually use the ozone oxidation method to remove formaldehyde in indoor air. The metal oxide catalytic degradation method is a relatively promising technology for formaldehyde degradation currently. In the metal oxide catalytic degradation method, a metal oxide having a catalytic function is used to catalyze formaldehyde decomposition under a normal temperature condition, and therefore the method has characteristics of fast reaction and no loss during a use process.

In the metal oxide catalytic degradation method, currently, catalysts that are relatively more studied are mainly noble metals such as platinum, palladium, and rhodium, a rare earth metal oxide, a transition metal, and a transition metal oxide, and the like. The noble metals such as platinum, palladium, and rhodium have advantages of good stability, high catalytic efficiency, and the like, but the application thereof is limited due to a high price. Rare earth metals and transition metals have become alternative materials of noble metals due to their relatively low prices and relatively high catalytic activity. Many transition metals have a plurality of variable valence states, and complex defects are easily formed in their oxides, and therefore the transition metals have relatively strong oxidation-reduction ability. For example, in the patents CN107626299A, CN105107524B, and CN106238065B, the following has been disclosed: One or more composite oxides of manganese, copper, silver, iron, and lanthanum have obvious activity of catalytic decomposition of formaldehyde at normal temperature. In these disclosed composite catalyst combinations, an oxygen storage characteristic difference between different metal oxides is mainly used to regulate a concentration of active oxygen, while it is difficult to achieve a synergistic effect thereof in an actual operation. In addition, technological processes of preparation methods of these composite oxides are relatively complex. In this case, it is difficult to obtain a catalyst material with good consistency, and it is difficult to implement extensive actual use.

In a gas-solid catalytic reaction system, contact efficiency between a catalyst and air containing pollutants such as formaldehyde directly determines a final catalytic effect, and therefore specific surface area selection of a catalyst and a carrier is also very critical. Most of existing catalyst materials are micron-sized packing particles and do not have specific surface areas large enough, and it is difficult to use catalytic activity of a catalyst in a catalytic degradation process of pollutants such as aldehydes.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a nano-catalyst composite for decomposing formaldehyde at room temperature. The nano-catalyst composite includes an alumina carrier of a nano dual-via structure. An inner part and a surface of the nano-alumina dual-via structure are loaded with a non-stoichiometric nano-metal manganese dioxide (MnO₂₋ₓ) catalyst. The catalyst for decomposing formaldehyde at the room temperature is the non-stoichiometric nano-metal manganese dioxide (MnO₂₋ₓ) catalyst.

Optionally, a nano-catalyst composite includes a catalyst carrier being an alumina of a nano dual-via structure.

Optionally, a catalyst carrier is an alumina of a nano dual-via structure.

Optionally, a non-stoichiometric ratio x of the nano manganese dioxide (MnO₂₋ₓ) catalyst is between 0.05 and 0.2, and preferably 0.08 to 0.15.

Optionally, a pore diameter of the alumina of a nano dual-via structure is between 80 nm and 350 nm, and preferably 100 nm to 300 nm.

Optionally, a non-stoichiometric nano-metal manganese dioxide (MnO₂₋ₓ) catalyst is loaded onto the inner part and the surface of the nano-alumina dual-via structure.

In other embodiments, the disclosure provides a preparation method of a nano-catalyst composite which includes the following steps. (1) Loading manganese dioxide onto the nano-alumina carrier by an electron beam thermal evaporation technology. (2) Conducting hydrogenation treatment on the manganese dioxide catalyst on the nano-alumina carrier under a condition of specific hydrogen pressure, specific temperature, and a specific hydrogenation time, to obtain the non-stoichiometric nano manganese dioxide (MnO₂₋ₓ) catalyst.

Optionally, a hydrogen pressure range in the hydrogenation treatment condition is 1.5 MPa to 2.5 MPa, and preferably 1.8 MPa to 2.2 MPa.

Optionally, a temperature range in the hydrogenation treatment condition is 280° C. to 420° C., and preferably 320° C. to 380° C.

Optionally, a hydrogenation treatment time range in the hydrogenation treatment condition is 2 hours to 6 hours, and preferably 3 hours to 5 hours.

In further embodiments, a hydrogenation process is to obtain an adjustable oxygen vacancy concentration and a ratio between lattice oxygen and surface oxygen in order to adjust a concentration of adsorbed oxygen on a surface of the manganese dioxide and to improve activity of formaldehyde catalytic degradation of the nano manganese dioxide (MnO₂₋ₓ).

### BRIEF DESCRIPTION OF THE DRAWINGS

FIG. 1 is an SEM image of an alumina carrier of a nano dual-via structure and with a pore diameter of 100 nm.

FIG. 2 is an SEM image of nano manganese dioxide loaded on anodic aluminum oxide (AAO).

FIG. 3 shows a static-state detection apparatus for formaldehyde degradation.

FIGS. 4A through 4C show static-state formaldehyde degradation results.

### DETAILED DESCRIPTION

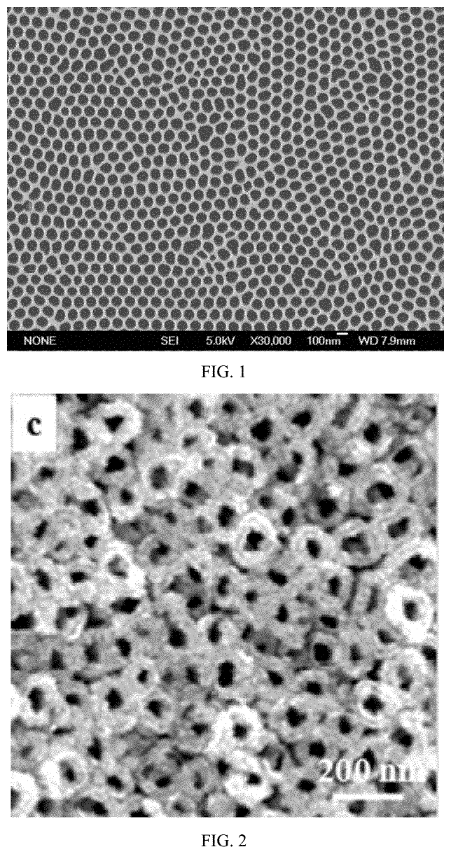

The following describes some non-limiting exemplary embodiments of the disclosure with references to the accompanying FIGS. 1-4C.

### Embodiment 1

A porous anodic aluminum oxide (AAO) alumina carrier of a dual-via structure and with a pore diameter of 100 nm is used. The via structure is shown in FIG. 1, and a diameter of a circular nano-alumina carrier is φ50 mm and a thickness thereof is 120 μm. A manganese dioxide target material is prepared by pressing manganese dioxide powder with purity of 99.99%. A nano-catalyst composite is prepared according to the following steps. (1) Manganese dioxide loading: loading a specific amount of manganese dioxide onto the AAO alumina carrier of a dual-via structure in a vacuum electron beam evaporation device by a suitable technology. FIG. 2 shows a morphology of nano manganese dioxide loaded onto the AAO. (2) Hydrogenation treatment: placing the dual-via alumina carrier loaded with the manganese dioxide in a high-pressure hydrogenation reactor, conducting vacuumizing first, heating to 320° C. at a heating rate of 5° C./min, introducing pure hydrogen gas until pressure reaches 1.5 MPa, conducting heat preservation for 4 hours, then naturally cooling to room temperature, and finally conducting depressurization to obtain a hydrogenated nano-catalyst composite. X-ray diffraction results show that a hydrogenated sample is still manganese dioxide of a typical orthorhombic phase, but a unit cell volume is reduced. It is determined through X-Ray diffraction results that x is 0.11 (MnO_{1.89}).

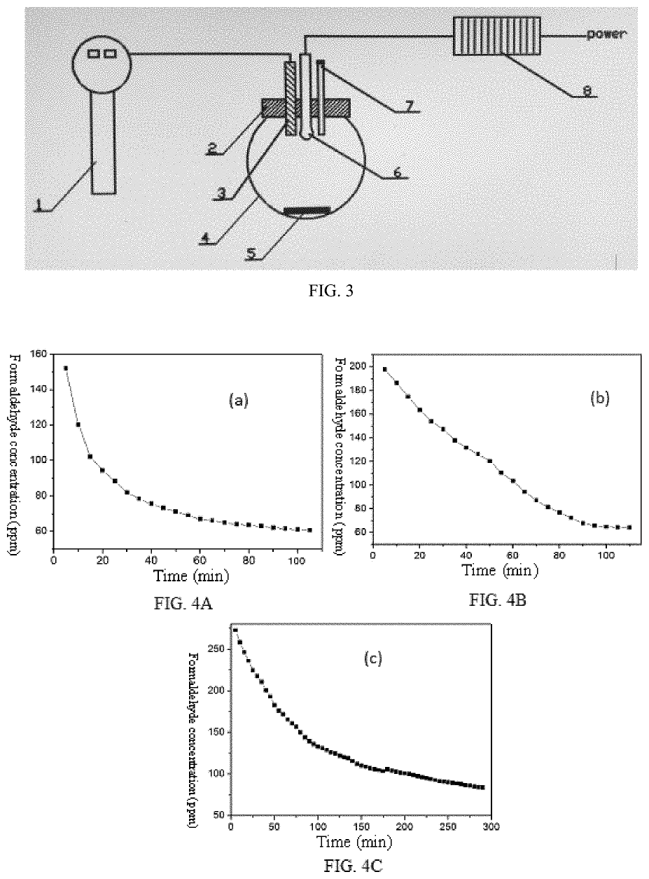

An experiment of decomposing formaldehyde at room temperature is conducted in a static-state detection apparatus shown in FIG. 3. As shown in FIG. 3, 1 is formaldehyde detector, 2 is container cap, 3 is sampling head, 4 is glass container, 5 is photocatalyst, 6 is light source, 7 is gas injection port, and 8 is transformer. In an experiment of decomposing formaldehyde, a nano-catalyst composite 5 is placed to the bottom of a closed vessel 4, a specific amount of formaldehyde gas is injected from a gas injection port 7 by using a micro sampling needle, and a formaldehyde detector detects a concentration change of the formaldehyde in the vessel in real time by using a sampling head 3 and records data every five minutes.

Exemplary test results are shown in FIG. 4A. In this experiment group, the non-stoichiometric manganese dioxide is MnO_{1.89}, and the hydrogenation treatment condition is 320° C./1.5 MPa/4 hours. As shown in FIG. 4A, after 100 minutes, a degradation rate of formaldehyde at the room temperature is 57.6%.

### Embodiment 2

A preparation process of a catalyst composite for decomposing formaldehyde at room temperature is the same as that in Embodiment 1, but the hydrogenation condition of the dual-via alumina carrier loaded with the manganese dioxide is changed to the following: 350° C. hydrogenation temperature, 2.0 MPa hydrogen pressure, and 4 hours heat preservation. The x value measured by an X-ray diffraction experiment is 0.15 (MnO_{1.85}). An experiment of decomposing formaldehyde at room temperature is conducted the same as that conducted in Embodiment 1.

Exemplary test results are shown in FIG. 4B. In this experiment group, the non-stoichiometric manganese dioxide is MnO_{1.85}, and the hydrogenation treatment condition is 350° C./2 MPa/4 hours. As shown in FIG. 4B, after 100 minutes, a degradation rate of formaldehyde at the room temperature is 70%.

### Embodiment 3

A preparation process of a catalyst composite for decomposing formaldehyde at room temperature is the same as that in Embodiment 1, but the hydrogenation condition of the dual-via alumina carrier loaded with the manganese dioxide is changed to the following: Hydrogenation temperature is 380° C., hydrogen pressure is 2.5 MPa, and heat preservation is conducted for 5 hours. x measured by an X-ray diffraction experiment is 0.18 (MnO_{1.82}). An experiment of decomposing formaldehyde at room temperature is conducted the same as that conducted in Embodiment 1,

Exemplary test results are shown in FIG. 4C. In this experiment group, the non-stoichiometric manganese dioxide is MnO_{1.82}, and the hydrogenation treatment condition is 380° C./2.5 MPa/4 hours. As shown in FIG. 4C, after 100 minutes, a degradation rate of formaldehyde at the room temperature is 54.5%.

Some embodiments of the disclosure may have one or more of the following effects. The disclosure may have characteristics such as high catalytic activity of decomposing formaldehyde at room temperature, adjustable concentration of active oxygen, good catalyst stability, simple preparation process, low costs, et cetera. The disclosure may be applied to the treatment of formaldehyde pollutants in air, especially the treatment of indoor formaldehyde pollutants and formaldehyde pollutants in a car. A nano-catalyst composite according to the disclosure may implement fast and efficient catalytic decomposition of formaldehyde in indoor air or formaldehyde in air in a car at room temperature. A non-stoichiometric nano-metal manganese dioxide (MnO₂₋ₓ) according to the disclosure may have a large quantity of oxygen vacancy defects, and a large amount of active oxygen may be adsorbed onto the surface and a surface layer of the non-stoichiometric nano-metal manganese dioxide, which may improve catalytic activity of decomposing formaldehyde at the room temperature. A nano-alumina carrier of a dual-via structure according to the disclosure may have very high mechanical strength, heat resistance, and corrosion resistance, which may be convenient for the design of a formaldehyde catalytic degradation reactor.

Other embodiments of the disclosure may have one or more of the following effects. (1) An active oxygen concentration may be controllable. Different oxygen vacancy concentrations and ratios between lattice oxygen and surface oxygen may be obtained by adjusting an x value in the non-stoichiometric manganese dioxide (MnO₂₋ₓ). (2) The catalyst composite may have stable performance and good consistency. The non-stoichiometric single-component manganese dioxide (MnO₂₋ₓ) material may be used according to the disclosure, and the electron beam thermal evaporation technology may be used for loading and ensure catalyst stability consistency. (3) The structure may be simple. The used nano-alumina carrier of a dual-via structure may have very high mechanical strength, and integrated loading of the nano-manganese oxide (MnO₂₋ₓ) may be used to implement a miniaturization of a formaldehyde catalytic degradation reactor. (4) The non-stoichiometric manganese dioxide (MnO₂₋ₓ) catalyst may be used to decompose formaldehyde at room temperature without additional energy. Environmental pollution in a degradation process may be minimized.

The foregoing embodiments are merely used for description of the disclosure, and do not constitute any limitation on the disclosure. A person of ordinary skill in the related technical field can make various modifications and variations to the disclosure without departing from the spirit and scope of the disclosure Therefore, all equivalent technical solutions fall within the scope of the disclosure, and the protection scope of the disclosure shall not be limited by the claims.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A nano-catalyst composite for decomposing formaldehyde at room temperature, prepared by a method comprising the steps of:
(1) loading manganese dioxide onto a nano-alumina carrier by an electron beam thermal evaporation technology; and
(2) conducting a hydrogenation treatment on the manganese dioxide on the nano-alumina carrier under a condition of specific hydrogen pressure, specific temperature, and a specific hydrogenation time, to obtain a non-stoichiometric nano manganese dioxide (MnO₂₋ₓ) catalyst;
wherein:
the nano-catalyst composite comprises an alumina carrier of a nano dual-via structure; and
an inner part and a surface of the alumina carrier of the nano dual-via structure are loaded with a non-stoichiometric nano-metal manganese dioxide (MnO₂₋ₓ) catalyst.

2. The nano-catalyst composite according to claim 1, wherein the formaldehyde is decomposed at room temperature by the non-stoichiometric nano-metal manganese dioxide (MnO₂₋ₓ) catalyst of the nano-catalyst composite.

3. The nano-catalyst composite according to claim 2, wherein a non-stoichiometric ratio x of the nano manganese dioxide (MnO₂₋ₓ) catalyst is between 0.05 and 0.2.

4. The nano-catalyst composite according to claim 1, further comprising a catalyst carrier, the catalyst carrier being an alumina of a nano dual-via structure.

5. The nano-catalyst composite according to claim 4, wherein a pore diameter of the alumina of a nano dual-via structure is between 80 nm and 350 nm.

6. The nano-catalyst composite according to claim 1, wherein a pore diameter of the alumina carrier of a nano dual-via structure is between 80 nm and 350 nm.

7. The nano-catalyst composite according to claim 1, wherein a non-stoichiometric ratio x of the nano manganese dioxide (MnO₂₋ₓ) catalyst is between 0.05 and 0.2.

8. A preparation method of a nano-catalyst composite for decomposing formaldehyde at room temperature comprising the steps of:
(1) loading manganese dioxide onto a nano-alumina carrier by an electron beam thermal evaporation technology; and
(2) conducting a hydrogenation treatment on the manganese dioxide on the nano-alumina carrier under a condition of specific hydrogen pressure, specific temperature, and a specific hydrogenation time, to obtain a non-stoichiometric nano manganese dioxide (MnO₂₋ₓ) catalyst.

9. The preparation method according to claim 8, wherein in the hydrogenation treatment condition, the specific hydrogen pressure is between 1.5 MPa and 2.5 MPa, the specific temperature is between 280° C. and 420° C., and the specific hydrogenation time is between 2 hours and 6 hours.
